(19) United States
(12) Patent Application Publication
(10) Pub. No.: US 2004/0037067 A1
(43) Pub. Date: Feb. 26, 2004

(54) Illumination ring alerting others of the presence of the ring wearer

(76) Inventor: Suzette H. Elwonger, Dallas, TX (US)

Correspondence Address: Michael L. Diaz, Michael L. Diaz, P.C., Suite 200, 555 Republic Drive, Plano, TX, 75074, US

(21) Appl. No.: 10/227,944

(22) Filed: Aug. 26, 2002

(51) Int. Cl. F21V 21/08

(52) U.S. Cl. 362/104; 362/571; 362/570; 362/565; 362/108; 362/800

(57) ABSTRACT

An illumination ring providing illumination of a wearer to nearby motorists. The illumination ring includes an elastomeric band having a light-emitting diode (LED) light source powered by a lithium battery. Both the LED light source and the lithium battery are affixed to the elastomeric band. The wear preferably wears the illumination ring on the individual's finger, thus providing illumination of the wearer to others.

### BACKGROUND OF THE INVENTION

1. Technical Field of the Invention

This invention relates to illumination devices, and more particularly, to an illumination ring for alerting others of the presence of the ring wearer.

2. Description of Related Art

Various types of exercise activities have become an important part of many individuals' lives. Many of the more popular exercise activities are those which require an individual to be close to a roadway. For example, many individuals run, bike, or walk along a sidewalk or at the side of the road. However, although these various forms of exercise are an important part of many individuals' lives, the hectic schedules do not allow for exercise within daylight hours. Rather than forego exercise, many individuals exercise at night. Although a popular time to exercise, there are several dangers an individual encounters when exercising at night. First and foremost, the greatest danger is from motorists traveling the same roadways as those utilized by the exercising individuals. Since at night visibility is reduced, motorists have great difficulty seeing individuals located near a roadway. In addition, due to the lack of light, the exercising person may have difficulty in seeing the pathway on which the individual travels, making it dangerous in avoiding obstacles along the pathway.

Many types of devices have been employed by these exercising individuals to alert motorists of the presence of the exercising individuals. One of the more common devices used by exercising individuals is reflective apparel. When a motorist shines his headlights on an individual wearing reflective clothing, the light reflects back, thus partially illuminating the individual to the motorists. Although these reflective devices provide some warning to the motorist, there are some severe limitations in using reflective gear. The reflective clothing does not provide its own illumination, but rather, depends on the light generated from the motorist's headlights. If the motorist's lights do not hit the reflective clothing at the correct angle, the light does not reflect back at the motorist. In addition, although the reflective light provides some type of warning to the motorist, it does not necessarily provide sufficient warning to the motorist to react in an appropriate manner to avoid the exercising individual.

Another type of device commonly used are headlamps which are mounted on the front of bicycles. The light from these devices provide illumination for the bicyclists, as well as some indication to the motorist of the impending travel of the bicyclist. However, the headlamps are bulky, heavy and expensive. Obviously, these devices are unsuitable for a walking or running individual. A device is needed which provides a light-weight, inexpensive way of illuminating the exercising individual to nearby motorists.

Review of the foregoing references reveals no disclosure or suggestion of a light-weight device for illuminating an exercising individual to nearby motorists. Thus, it would be a distinct advantage to have an illumination ring to alert a motorist of the presence of an exercising individual. It is an object of the present invention to provide such a device.

### SUMMARY OF THE INVENTION

In one aspect, the present invention is an illumination apparatus for wear by an individual. The illumination apparatus includes a light-emitting source, a power source to power the light-emitting source, and a band attached to the individual. The light-emitting source and the power source are affixed to the band. The light-emitting source generates illumination to warn nearby motorists of the presence of the individual.

In another aspect, the present invention is an illumination ring worn by an individual. The ring includes a light-emitting diode (LED), a lithium battery to power the LED, and an elastomeric band attached to a finger of the individual. The LED and the lithium battery is attached to the band. The LED generates illumination to warn nearby motorists of the presence of the individual.

In still another aspect, the present invention is an illumination apparatus worn by an individual. The illumination apparatus includes a light-emitting source and a power source to power the light-emitting source. The light-emitting source and power source are affixed to the individual. The light-emitting source provides illumination to warn nearby motorists of the presence of the individual.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a side view of an exercising individual wearing an illumination ring in the preferred embodiment of the present invention;

FIG. 2 is an enlarged front perspective view of the illumination ring of FIG. 1 removed from the individual;

FIG. 3 is a top view of the ring;

FIG. 4 is a side view of the illuminating device removed from the illumination ring;

FIG. 5 is a front perspective view of the individual wearing the illumination ring on a bicycle; and

FIG. 6 is a front perspective view of the individual wearing an illuminating device in an alternate embodiment of the present invention.

### DETAILED DESCRIPTION OF EMBODIMENTS

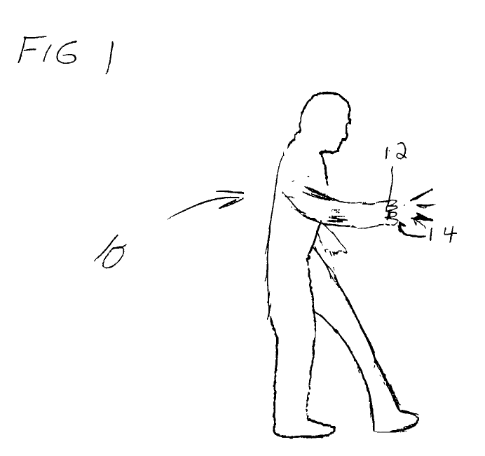

An illumination ring for wear by an exercising individual to alert nearby motorists of the presence of the individual is disclosed. FIG. 1 is a side view of an exercising individual 10 wearing an illumination ring 12 in the preferred embodiment of the present invention. The illumination ring is preferably worn on a finger 14 of the individual.

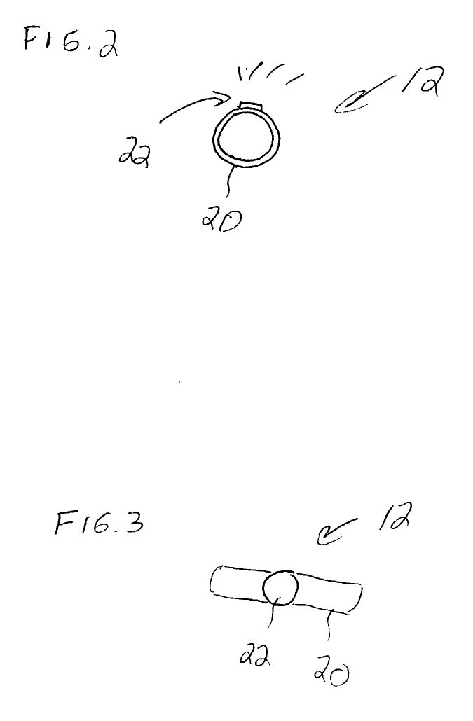

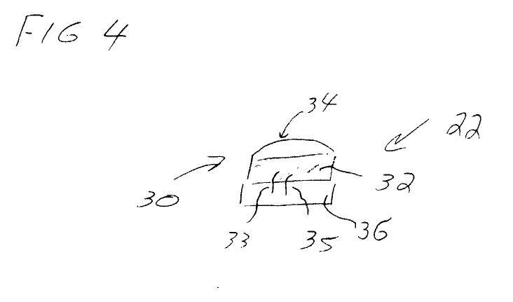

FIG. 2 is an enlarged front perspective view of the illumination ring 12 of FIG. 1 removed from the individual 10. FIG. 3 is a top view of the ring 12. The ring includes a band 20, preferably constructed of an elastomeric material. Upon a top portion of the ring is an illuminating device 22. The illuminating device's primary function is to warn nearby motorists of the presence of the individual wearing the ring. The illuminating device may also perform a secondary function of providing light to illuminate the ground in front of the individual.

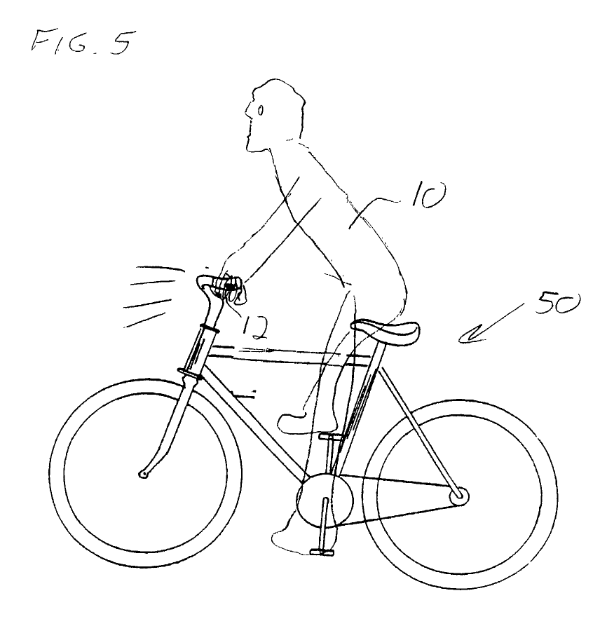

FIG. 4 is a side view of the illuminating device 22 removed from the illumination ring 12. The illuminating device preferably includes a light-emitting diode (LED) 30 as its source of illumination. Although any illumination device may be used, such as chemical reactive lights or incandescent lights, the LED provides many advantages over existing light sources. The life of a LED is much greater than other types of light sources (e.g., incandescent light sources), often lasting longer than 100,000 hours of use. Additionally, LEDs can sustain more and harder impacts than incandescent light bulbs. Also, LEDs do not produce the immense amount of heat that incandescent light sources normally produce. The LEDs also are very light. All of these characteristics makes the choice of a LED particularly appropriate for the illumination ring 12. However, in alternate embodiments of the present invention, the illuminating device 22 may be any light source.

Still referring to FIG. 4, the LED 30 typically includes a light-emitting core 32 and two leads 33 and 35. An epoxy dome 34 preferably covers the core for protection of the light-emitting core. However, there are a wide variety of other housings and domes which may be used to cover the core. The leads include two electrodes (not shown), an anode and a cathode. The anode accepts a positive voltage and the cathode accepts the negative portion of an electronic circuit. The leads are connected to a power source 36. In the preferred embodiment of the present invention, the power source is an approximately dime-sized lithium battery. The lithium battery is light, durable and provides sufficient power to power the LED 30. The LED and power source are both affixed to the band 20.

With reference to FIGS. 1-4, the operation of the illumination ring 12 will now be explained. The illumination ring includes the illuminating device 22, which provides a light to warn nearby motorists of the presence of the individual 10. The illuminating device, in the preferred embodiment of the present invention, comprises the LED 30 having the light-emitting core 32 which is powered by the power source 36. The illuminating device 22 is affixed to the band 20. With the use of an elastomeric material, the ring may fit virtually any size finger. In addition, elastomeric material is resistant to damage caused by sweat or water. However, the band may be constructed of any material which securely fastens the band to the finger of the individual. The ring is worn by the exercising individual. The illuminating device emits a light which may be easily seen by nearby motorists, thus alerting the motorists of the presence of the individual. The illuminating device may include a flashing light display or a steady light. Activation of the ring may be by any mechanism. For example, the illumination device may be activated by twisting a portion of the illumination device to allow contact between the illumination device and the power source. In addition, various colors may be employed. The illuminating device may also be used to illuminate a path in front of the individual.

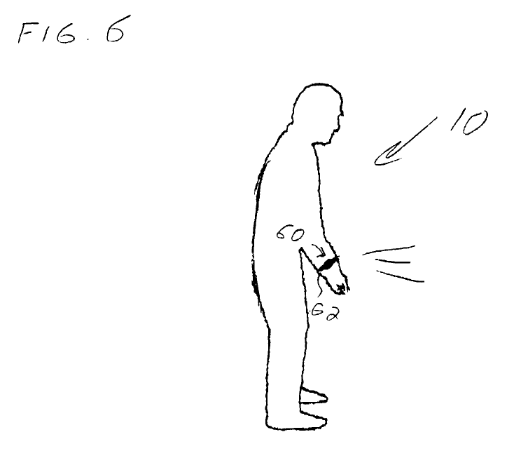

FIG. 5 is a front perspective view of the individual 10 wearing the illumination ring 12 on a bicycle 50. The individual may wear the illumination ring in a wide variety of activities, such as cycling. The individual may wear the illumination ring on the individual's finger 14, thus providing illumination in a forwardly direction relative to the bicycle. In an alternate embodiment of the present invention, a plurality of illuminating devices may be worn by the individual on various parts of the body of the individual, clothing worn by the individual, or on a portion of the bicycle itself.

FIG. 6 is a front perspective view of the individual 10 wearing an illuminating device 60 in an alternate embodiment of the present invention. The illuminating device may also be worn on any part of the individual's body or clothing. For example, as depicted in FIG. 5, the illumination device may be worn as a bracelet on a wrist of the individual. The illuminating device may be affixed to a band 62 surrounding the wrist of the individual. The band may be constructed of an elastomeric material. In alternate embodiments of the present invention, the illuminating device may be worn by the individual on any part of the body or clothing. The illuminating device may be affixed by any device allowing the illuminating device to be comfortably worn by the individual, such as by a safety pin or a cord.

The illumination ring 12, as well as the illuminating device 60 provide several advantages over existing reflective clothing. The present invention enables an exercising individual to provide a warning to nearby motorists of the presence of the individual. The present invention is light, durable, inexpensive, and unobtrusive in its wear by the individual. The present invention also provides a simple, yet effective, safety device to the exercising individual.

It is thus believed that the operation and construction of the present invention will be apparent from the foregoing description. While the device shown and described has been characterized as being preferred, it will be readily apparent that various changes and modifications could be made therein without departing from the scope of the invention as defined in the following claims.

What is claimed is:

1. An illumination apparatus for wear by an individual, said illumination apparatus comprising:
a light-emitting source;
a power source to power said light-emitting source; and
a band attached to the individual, said light-emitting source and said power source being affixed to the band;
whereby said light-emitting source generates illumination to warn nearby motorists of the presence of the individual.

2. The illumination apparatus of claim 1 wherein:
the illumination apparatus is a ring; and
said band surrounds a finger of the individual when wearing the ring.

3. The illumination apparatus of claim 2 wherein said band is constructed of an elastomeric material.

4. The illumination apparatus of claim 1 wherein the light-emitting source is a light-emitting diode (LED).

5. The illumination apparatus of claim 4 wherein the LED has a LED core having two leads attached to said power source.

6. The illumination apparatus of claim 5 wherein said power source is a lithium battery.

7. The illumination apparatus of claim 1 wherein said band is affixed to a limb of the individual.

8. The illumination apparatus of claim 1 wherein the band is affixed to clothing worn by the individual.

9. An illumination ring worn by an individual, said illumination ring comprising:
a light-emitting diode (LED);
a lithium battery to power said LED; and
an elastomeric band attached to a finger of the individual, said LED and said lithium battery being affixed to said band;
whereby said LED generates illumination to warn nearby motorists of the presence of the individual.

10. The illumination ring of claim 9 wherein said LED includes a LED core having two leads leading to said lithium battery.

11. The illumination ring of claim 9 wherein said LED illuminates a flashing light to warn nearby motorists.

12. An illumination apparatus worn by an individual, said illumination apparatus comprising:
a light-emitting source;
a power source to power said light-emitting source; and
means for affixing said light-emitting source and said power source to the individual;
whereby said light-emitting source generates illumination to warn nearby motorists of the presence of the individual.

13. The illumination apparatus of claim 12 wherein said means for affixing said light-emitting source and said power source to the individual includes affixing said light-emitting source and said power source to apparel worn by the individual.

14. The illumination apparatus of claim 12 wherein said light-emitting source is affixed to said power source.

15. The illumination apparatus of claim 12 wherein said light-emitting source is a light-emitting diode (LED).

16. The illumination apparatus of claim 12 where said light-emitting source illuminates a flashing light.
